(19) United States
(12) Patent Application Publication
(10) Pub. No.: US 2026/0252606 A1
(43) Pub. Date: Aug. 27, 2026

(54) HALLUCINATION DETECTION IN TEXT GENERATING SYSTEM

(71) Applicant: Infosys Limited, Bangalore (IN)

(72) Inventor: Janani VARUN, Chennai (IN)

(73) Assignee: Infosys Limited, Bangalore, KA (IN)

(21) Appl. No.: 19/268,563

(22) Filed: Jul. 14, 2025

(30) Foreign Application Priority Data
Feb. 24, 2025 (IN) 202541015914
Jul. 9, 2025 (IN) 202541015914

(51) Int. Cl. G06F 16/334; G06F 40/226; G06F 40/30

(52) U.S. Cl. CPC G06F 16/334; G06F 40/226; G06F 40/30

(57) ABSTRACT

A system for hallucination detection in text generating systems is provided. The system includes processing circuitry that accesses a query and determines a first query-type associated therewith. The processing circuitry accesses a proposed query response for the query. Based on the proposed query response, the processing circuitry generates a set of parameter values for a set of parameters. Based on the set of parameter values and a first set of adaptive weights associated with the set of parameters, the processing circuitry determines a hallucination magnitude for the proposed query response. Based on the hallucination magnitude and a hallucination threshold associated with the first query-type, the processing circuitry generates a hallucination indicator indicative of a presence or an absence of hallucination in the proposed query response.

### FIELD OF THE DISCLOSURE

Various embodiments of the present disclosure relate generally to hallucination detection. More specifically, various embodiments of the present disclosure relate to hallucination detection in text generating systems.

### BACKGROUND

Exponential advancement in the field of technology has given rise to multiple text generating tools (for example, search tools, large language model powered bots, or the like) that may be used to access information associated with various domains, such as healthcare, finance, traffic management, urban planning, manufacturing, or the like. These text generating tools receive queries from users and utilize available data sources for generating responses to the queries. In many cases, the responses are factually correct and contextually relevant to the queries, creating an impression of reliability. However, despite their fluency, the text generating tools may sometimes produce inaccurate or misleading information. This phenomenon is referred to as hallucination. For example, for a query, “Who discovered penicillin?”, a text generating system may generate a response as, “Alexander Graham Bell discovered penicillin.” In this example, the response generated by the text generating system is fluent and grammatically well-formed, which may initially give an impression of being correct. However, upon closer inspection, the response contains a factual inaccuracy. The text generating system incorrectly attributes the discovery of penicillin to Alexander Graham Bell, whereas the ground truth response for the query is Alexander Fleming, who discovered penicillin in 1928.

This illustrates a typical case of hallucination, where the text generating system produces a confident and natural-sounding response that is factually incorrect. Such responses can be misleading, especially when the surface fluency masks underlying errors. Such hallucination in the responses may be caused by various factors, such as due to the probabilistic nature of text generation, limitations in training data, absence of real-time fact verification, lack of factual grounding in the available data sources, ambiguous or vague queries, overgeneralization from learned patterns, or the like. The text generating tools may generate responses based on statistical associations rather than grounded knowledge, which can lead to plausible-sounding but factually incorrect or fabricated responses. Such responses may provide the users with information that may be incorrect and/or unreliable.

Notably, based on the text generating tools being widely used and trusted for accessing information, the reliability of the responses generated by the text generating tools becomes significant. For example, in areas like healthcare, the text generating tools may be used to access information that may aid in the diagnosis of patients. In such an example, hallucination in response to a query for accessing information for aiding the diagnosis may lead to a misdiagnosis or improper treatment, which is undesirable. Similarly, the text generating tools may be used for accessing information for various other domains (for example, tourism, navigation, education, research, or the like) that may have a significant role in the everyday lives of users thereof. Hence, hallucination in the responses for queries from such domains may pose a negative effect on the everyday lives of the users. The abovementioned disadvantages associated with hallucination in the responses may discourage the users from accessing information via the text generating tools, which is undesirable.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for hallucination detection are provided substantially as shown in, and described in connection with, at least one of the figures.

In an embodiment of the present disclosure, a system is disclosed. The system comprises processing circuitry. The processing circuitry is configured to access a query. The processing circuitry is further configured to determine a first query-type associated with the query. The processing circuitry is further configured to access a proposed query response for the query. The processing circuitry is further configured to generate, based on the proposed query response, a set of parameter values for a set of parameters. The set of parameter values is indicative of a degree of grounding associated with the proposed query response. The processing circuitry is further configured to determine, based on the set of parameter values and a first set of adaptive weights associated with the set of parameters, a hallucination magnitude for the proposed query response. The processing circuitry is further configured to generate, based on the hallucination magnitude and a hallucination threshold associated with the first query-type, a hallucination indicator for the proposed query response.

In some embodiments, the processing circuitry is further configured to compare the hallucination magnitude and the hallucination threshold. The hallucination indicator indicates a presence of hallucination in the proposed query response based on the hallucination magnitude being greater than the hallucination threshold. The hallucination indicator indicates an absence of hallucination in the proposed query response based on the hallucination magnitude being less than the hallucination threshold.

In some embodiments, the processing circuitry is further configured to analyze the query to determine the first query-type from a plurality of query-types. For each query-type of the plurality of query-types, the set of parameters is associated with a corresponding set of adaptive weights. The first set of adaptive weights is determined further based on the first query-type being associated with the query.

In some embodiments, the processing circuitry is further configured to parse a set of query tokens in the query. The processing circuitry is further configured to determine a contextual intent of each query token of the set of query tokens. The query is analyzed based on the contextual intent of each query token of the set of query tokens.

In some embodiments, the plurality of query-types include at least two of: a factual query-type, a procedural query-type, a creative query-type, a mythical query-type, or an unknown query-type.

In some embodiments, the set of parameters includes at least one of: a brevity score, an entropy indicator, an inter-token delay, or a cosine similarity. A first parameter value for the brevity score is generated by utilizing a first count of tokens in a first set of tokens pertaining to the proposed query response and a second count of tokens in a second set of tokens pertaining to a ground truth response for the query. A second parameter value for the entropy indicator is generated by utilizing information contribution of each token of the first set of tokens. A third parameter value for the inter-token delay is generated by utilizing a time-interval between generation of two adjacent tokens in the first set of tokens. A fourth parameter value for the cosine similarity is generated by utilizing a vector representation of the query and the proposed query response. The first parameter value, the second parameter value, the third parameter value, and the fourth parameter value, collectively, constitute the set of parameter values.

In some embodiments, the system further includes a storage element coupled to the processing circuitry, and the processing circuitry is further configured to create a database associated with a subject area of the first query-type. The processing circuitry is further configured to store the database in the storage element. The processing circuitry is further configured to generate, based on the query being associated with the first query-type, the ground truth response for the query by utilizing the database.

In some embodiments, the processing circuitry is further configured to compare the hallucination indicator with an actual hallucination state associated with the proposed query response. The processing circuitry is further configured to determine, based on the hallucination indicator being different from the actual hallucination state, that the hallucination indicator corresponds to one of a false-positive hallucination indicator or a false-negative hallucination indicator. The processing circuitry is further configured to generate, based on the hallucination indicator corresponding to one of the false-positive hallucination indicators or the false-negative hallucination indicator, a new set of adaptive weights associated with the set of parameters for the first query-type. The new set of adaptive weights is generated based on at least one of: the first set of adaptive weights, the hallucination indicator, the actual hallucination state, a pre-defined learning rate for the set of parameters, or a direction of correction associated with the first set of adaptive weights.

In some embodiments, the processing circuitry is further configured to generate for the first query-type, a set of adaptive thresholds for the set of parameters based on at least one of: a historical set of adaptive thresholds associated with the set of parameters for the first query-type, a learning rate associated with the set of parameters for the first query-type, a metric of historical false-positive hallucination indicators for the first query-type, a metric of historical false-negative hallucination indicators for the first query-type, or a direction of correction associated with the historical set of adaptive thresholds. The processing circuitry is further configured to determine the hallucination threshold associated with the first query-type based on the set of adaptive thresholds for the set of parameters.

In some embodiments, a computer-implemented method is disclosed. The computer-implemented method includes accessing a query. The computer-implemented method further includes determining a first query-type associated with the query. The computer-implemented method further includes accessing a proposed query response for the query. The computer-implemented method further comprises generating, based on the proposed query response, a set of parameter values for a set of parameters. The set of parameter values is indicative of a degree of grounding associated with the proposed query response. The computer-implemented method further includes determining, based on the set of parameter values and a first set of adaptive weights associated with the set of parameters, a hallucination magnitude for the proposed query response. The computer-implemented method further includes generating, based on the hallucination magnitude and a hallucination threshold associated with the first query-type, a hallucination indicator for the proposed query response.

In some embodiments, a computer-readable medium is disclosed. The computer-readable medium includes instructions that, when executed by processing circuitry of a computing system, cause the computing system to perform a method for detection of hallucination in a proposed query response for a query, the method includes accessing the query. The method further includes determining a first query-type associated with the query. The method further includes accessing the proposed query response for the query. The method further includes generating, based on the proposed query response, a set of parameter values for a set of parameters. The set of parameter values is indicative of a degree of grounding associated with the proposed query response. The method further includes determining, based on the set of parameter values and a first set of adaptive weights associated with the set of parameters, a hallucination magnitude for the proposed query response. The method further includes generating, based on the hallucination magnitude and a hallucination threshold associated with the first query-type, a hallucination indicator for the proposed query response.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 illustrates a system environment for implementation of a hallucination detection system, consistent with disclosed embodiments of the present disclosure;

FIG. 2 is a block diagram that illustrates the hallucination detection system, consistent with disclosed embodiments of the present disclosure;

FIG. 3 depicts a schematic diagram that illustrates an implementation of the hallucination detection system, consistent with disclosed embodiments of the present disclosure;

FIG. 4 shows an example computing system for carrying out methods of the present disclosure, consistent with disclosed embodiments of the present disclosure; and

FIG. 5 illustrates a flowchart that depicts a method for detection of hallucination, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview:

With the continuous and rapid evolution of digital technologies, a wide array of text generating systems (for example, search tools, large language model powered bots, or the like) has emerged that support information access across numerous domains, ranging from healthcare and finance to transportation, manufacturing, and smart city infrastructure. The text generating systems may interpret queries and generate relevant responses using various data repositories and models. Generally, the responses are accurate, informative, and aligned with the intent behind the query. However, in some instances, the text generating systems may generate hallucinated responses that may appear coherent but may not be factually correct. Such hallucinations in responses may arise due to multiple factors, including the probabilistic nature of text generation, limitations in training data, absence of real-time fact verification, lack of factual grounding in the available data sources, ambiguous or vague queries, overgeneralization from learned patterns, or the like.

In domains where precision and correctness are of significant importance, such as clinical diagnostics, financial decision-making, or public safety, hallucinated information may lead to undesirable consequences, such as misinterpretation, flawed recommendations, or the like. Given the increasing reliance on text generating systems even for everyday tasks, ensuring factual integrity and reliability of the responses has become more important than ever.

Generally, the detection of hallucination in the responses is done post-response generation. Such detection may be performed based on verification of the response based on external trusted data sources. However, based on an application of the response being time sensitive, the verification of the response upon the generation of the response may not be an optimal approach. Notably, based on delayed or deferred detection of the hallucination in the response, incorrect information in the responses may be used. In many instances, such use of the responses may lead to inaccurate decisions being made. That is to say, users may trust and utilize the hallucinated responses prior to verifications thereof. Decisions made on incorrect information may cause financial and emotional damage to the users. Additionally, hallucination detection after generation of the responses may lead to computational overhead. That is to say, for verification of the generated responses, additional processing may be required for retrieving, comparing, and validating information in the responses against the external trusted data sources.

The present disclosure may provide an optimal approach for hallucination detection in text (for example, proposed query responses for queries) generated by text generating systems (for example, search tools, large language model powered bots, or the like) in real-time. The present disclosure allows for detection of hallucination in the proposed query responses, for the queries, generated by the text generating systems. The detection of hallucination in the proposed query responses may be performed by processing circuitry of a hallucination detection system. The processing circuitry may be configured to access a query. The processing circuitry may analyze the query. Based on the analysis of the query, the processing circuitry may determine an intent and a context associated with the query. The processing circuitry may utilize the determined intent and context associated with the query to identify a first query-type of the query. The first query-type may be a factual query-type, a procedural query-type, a creative query-type, a mythical query-type, or an unknown query-type.

The processing circuitry may be further configured to access a proposed query response, for the query, to be generated as a response to the query by the text generating system. A set of parameter values for a set of parameters may be generated based on the proposed query response. The set of parameters may include a brevity score, an entropy indicator, an inter-token delay, and a cosine similarity. The set of parameter values may be indicative of a degree of grounding associated with the proposed query response. The degree of grounding may correspond to an extent to which the proposed query response may be reliable.

Additionally, for each query-type of the plurality of query-types, the set of parameters may be associated with a corresponding set of adaptive weights. The set of adaptive weights may be dynamic. For the first query-type, each adaptive weight of a first set of adaptive weights of the set of parameters may be indicative of an extent to which a corresponding parameter of the set of parameters contributes to the hallucination detection in the proposed query response of the query of the first query-type.

The processing circuitry may determine, based on the set of parameter values and the first set of adaptive weights, a hallucination magnitude associated with the proposed query response. The hallucination magnitude may be indicative of a degree of hallucination in the proposed query response. Based on the hallucination magnitude and a hallucination threshold associated with the first query-type, a hallucination indicator may be generated for the proposed query response.

The processing circuitry may be further configured to compare the hallucination magnitude with the hallucination threshold associated with the first query-type. The hallucination indicator may indicate a presence of hallucination in the proposed query response based on the hallucination magnitude being greater than the hallucination threshold. Alternatively, the hallucination indicator may indicate an absence of hallucination in the proposed query response based on the hallucination magnitude being less than the hallucination threshold.

The disclosed system allows for real-time detection of hallucination in the proposed query response. Such hallucination detection may be performed by leveraging parameters, such as brevity score, entropy indicator, inter-token delay, and cosine similarity, which may act as indicators for the degree of grounding in the proposed query response. The disclosed system allows the use of the set of parameters based on the importance thereof for the first query-type of the query. In one example, for a query response of a query with the factual query-type, the entropy indicator may be of greater importance than cosine similarity. In another example, for a query response of a query with the mythical query-type or the creative query-type, the brevity indicator may be significant. This allows for a customized and optimal approach for the detection of hallucination of the proposed query response in real-time.

Moreover, the disclosed system significantly reduces time consumption and computation requirement for retrieval, analysis, processing, or the like associated with validation of the proposed query response after generation thereof. Hence, this allows for efficient utilization of computing resources for the detection of hallucination in the proposed query response. In addition, the disclosed system also reduces a latency associated with the detection of hallucination. Additionally, the detection of hallucination in real-time may ensure that the proposed query response remains credible and may be confidently used in time-sensitive tasks, such as automated customer support, patient diagnosis, or the like. To summarize, the disclosed system enhances user trust, supports informed decision-making, and ensures a higher degree of response integrity across various application domains.

### FIGURE DESCRIPTION

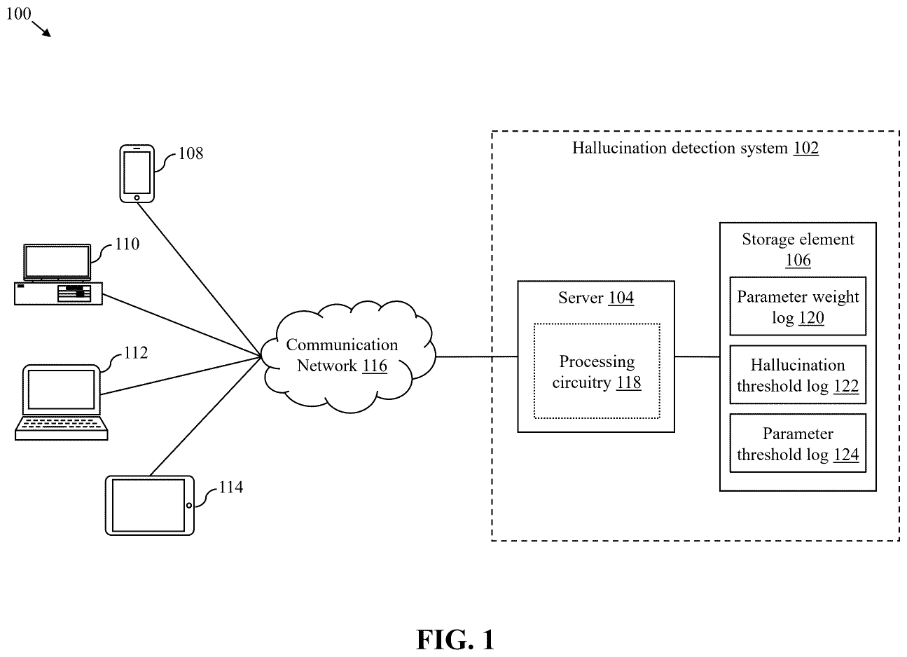

FIG. 1 illustrates a system environment 100 for implementation of a hallucination detection system 102, consistent with disclosed embodiments of the present disclosure. The hallucination detection system 102 may detect presence or absence of hallucination in text generated by text generating systems (for example, search tools, large language model powered bots, or the like).

Text generating systems have emerged as powerful means for solving complex real-world problems across various domains, such as healthcare, finance, traffic management, urban planning, manufacturing, or the like. The text generating systems may receive queries from users thereof and may generate text (such as query responses) for the queries. The text generating systems may use various underlying techniques (for example, large language models (LLMs), small language models (SLMs), and so on) for the generation of the query responses. The query responses may include contextual and factual data pertaining to the queries. In some instances, the query responses may exhibit hallucination. In other words, the query responses may sound plausible, but may be factually incorrect. Such hallucination in the query responses may be caused due to various reasons, such as sub-optimal training of the text generating systems (for example, an underlying technique used by the text generating systems) on training datasets that may be overfitted, underfitted, incomplete, inaccurate, or biased. The hallucination in the query responses may be caused further due to ambiguous or vague queries, or a lack of factual grounding in the available data sources. Additionally, the hallucination in the query responses may be due to probabilistic nature of text generation, absence of real-time fact verification, or the like.

The query responses with hallucination may lead the users of the text generating systems to rely on factually incorrect data that may cause inaccurate decision-making, which is undesirable. Hence, the detection of hallucination in the query responses generated by the text generating systems may be of significant value.

The system environment 100 includes the hallucination detection system 102, having a server 104 and a storage element 106. For detecting the presence or absence of hallucination in a proposed query response for a query, the hallucination detection system 102 may access the query and the proposed query response.

In some embodiments, the query may be generated within the hallucination detection system 102. Alternatively, in some embodiments, the query may be received by the hallucination detection system 102 via a user device associated therewith. Similarly, in some embodiments, the proposed query response may be generated, based on the query, within the hallucination detection system 102. In such embodiments, the hallucination detection system 102 may be integrated with the text generating system. Alternatively, in some embodiments, the proposed query response may be received by the hallucination detection system 102 via the user device associated therewith. In such embodiments, the user device may be an interface or a touchpoint associated with the text generating system.

As shown, the hallucination detection system 102 may be associated with a plurality of user devices 108-114 via a communication network 116. A user device, of the plurality of user devices 108-114, may include suitable logic, circuitry, interfaces, and/or code, executable by the circuitry, that may be configured to perform one or more operations for generating the query, receiving the proposed query response from the text generating system, and interacting with the hallucination detection system 102 for detection of hallucination in the proposed query response. Examples of the plurality of user devices 108-114 may include cell-phones, desktops, laptops, tablets, phablets, or the like. Each user device of the plurality of user devices 108-114 may be associated with a corresponding user (not shown). Each user device may have an application programming interface (API) associated with the text generating system. The API may be used to provide the query. Based on the query, the proposed query response may be generated. As used herein, the proposed query response may be a probable output of the query that is to be provided to the user via the user device. The proposed query response may refer to a response generated by the text generating system in reaction to the received query, wherein the proposed query response has been internally computed and formulated by the text generating system but has not yet been presented, transmitted, or outputted to the end user or an associated external system. The proposed query response represents a candidate output that may be subject to further evaluation, verification, modification, or filtering prior to being finalized and delivered as an actual response. This intermediate state allows for additional processing steps, such as hallucination detection, relevance scoring, or compliance checks, to be performed before the proposed query response is exposed externally.

The query and optionally the proposed query response before being presented to the user via the user device may be communicated to the hallucination detection system 102 for detection of presence or absence of hallucination in the proposed query response.

The API on the user device may interact with the hallucination detection system 102 for communicating the query and optionally the proposed query response, and receiving a hallucination indicated response indicative of the presence or absence of hallucination in the proposed query response. For the sake of brevity of the ongoing description, it is assumed that the query and the proposed query response may be communicated to the hallucination detection system 102 via the user device 108. The server 104 may receive the query and the proposed query response from the user device 108 via the communication network 116.

The communication network 116 may communicably couple the plurality of user devices 108-114 with the hallucination detection system 102. In other words, the communication network 116 may correspond to a communication channel or medium between the plurality of user devices 108-114 and the server 104. In some embodiments, the communication network 116 may also act as a communication channel or medium between the server 104 and the storage element 106. Examples of the communication network 116 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 116 may further include a Narrow Band-Internet of Things (NB-IoT) network, a 5G network, a 4G network, a long-range (LoRa) wireless technology network, a ZigBee network, an IPv6 Low-power Wireless Personal Area Network (6LowPAN), or the like. Various entities (such as, the server 104, the storage element 106, and the plurality of user devices 108-114) in the system environment 100 may be coupled to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof. The communication network 116 may communicate the query and the proposed query response to the server 104 in the form of data packets. The server 104 may receive the data packets and subsequently, may assemble the data packets to access the query and the proposed query response.

A query (for example, a user query) may be associated with a first query-type of a plurality of query-types. In some embodiments, the query may correspond to a user-query. For example, the query may be generated by a user associated with a user device (for example, the user device 108). In some other embodiments, the query may correspond to a system generated query generated by an automatic query generator of the text generating system that may be external to the hallucination detection system 102. The first query-type may be indicative of a categorized intent or underlying purpose of the query (for example, a context of the query), defined by the nature of information sought and an expected format of a desired response. The first query-type may be indicative of a semantic essence of the query, such as whether the user is seeking objective facts, imaginative content, procedural guidance, or speculative narratives.

The plurality of query-types may include a factual query-type, a procedural query-type, a creative query-type, a mythical query-type, or an unknown query-type. The first query-type may be the factual query-type, the procedural query-type, the creative query-type, the mythical query-type, or the unknown query-type. The factual query-type may be associated with queries pertaining to well-documented facts, historical events, scientific principles, or the like. For example, ‘What is the capital of France?’. The mythical query-type may be associated with queries pertaining to legends, folklore, or fictional belief systems, rather than empirical evidence or reality. For example, ‘Who was the king of Atlantis?’. The procedural query-type may be associated with queries pertaining to a sequence of operations, step-by-step instructions or guidelines to complete a specific task, process, or workflow. For example, ‘How to perform CPR on an adult?’.

The creative query-type may be associated with queries that may be intended to inspire or request original content, such as stories, poems, dialogues, or ideation, where creativity and uniqueness may be significant. For example, ‘Write a short poem about the sea.’ Further, the unknown query-type may be associated with queries that may not have an identifiable query-type. For example, ‘What are the cultural impacts of hypothetical civilizations?’. To summarize, the query may have a query-type that may be indicative of an intent of the query and a purpose of a desired query response for the query. The desired query response may refer to an expected format, content, quality, or objective of an output or reply to be generated for the query. The desired query response may be factually and contextually valid. The desired query response may be similar to a ground truth response associated with the query. Based on the absence of hallucination in the proposed query response, the proposed query response may be identical to the desired query response. Based on the presence of hallucination in the proposed query response, the proposed query response may be different from the desired query response. To summarize, the desired query response may indicate the kind of answer a user expects (for example, facts, figures, definitions, or the like). This allows the hallucination detection system 102 to estimate what kind of response should be provided precisely to satisfy the user's informational needs.

The server 104 may access the query and the proposed query response. The server 104 may include suitable logic, circuitry, interfaces, and/or code, that when executed, may perform one or more operations for the detection of hallucination in the proposed query response for the query. The server 104 may include one or more physical or virtual machines, configured to provide data, functionality, computational resources, or services to the plurality of user devices 108-114 over the communication network 116. The server 104 may include, without limitation, one or more processors, memory units, input/output interfaces, and network communication modules. The server 104 may host software components, databases, or application logic, and may be configured to receive requests from remote client devices, process the received requests, and transmit responses or data accordingly. The server 104 may operate in a centralized, distributed, or cloud-based environment and perform its functions independently or in coordination with other servers or computing entities. The server 104 is shown to include processing circuitry 118 that may be configured to execute one or more operations for the detection of hallucination in the proposed query response.

The processing circuitry 118 may include suitable logic, circuitry, interfaces, and/or code, executable by the circuitry, that may be configured to execute one or more operations for the detection of hallucination in the proposed query response. The processing circuitry 118 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person skilled in the art that the processing circuitry 118 may be compatible with multiple operating systems. The processing circuitry 118 may further include one or more components (for example, a parser, a loader, or the like) that may be configured to execute one or more operations to be executed by the processing circuitry 118. Throughout the description, an operation performed by the server 104 may be performed by the processing circuitry 118.

In operation, the processing circuitry 118 may be configured to access the query and the proposed query response. The processing circuitry 118 may be further configured to process and analyze the query to determine the first query-type associated therewith. The first query-type may be one of the plurality of query-types, including the factual query-type, the procedural query-type, the creative query-type, the mythical query-type, or the unknown query-type. Based on the determination of the first query-type, the processing circuitry 118 may further determine a set of parameter values for a set of parameters that may be required for establishing a degree of grounding in the proposed query response.

The degree of grounding may correspond to an extent to which the proposed query response may be reliable, verifiable, and contextually valid. The degree of grounding may reflect how well the proposed query response may be anchored in factual data, established knowledge, or relevant evidence, rather than being speculative, fabricated, or disconnected from real-world references. A high degree of grounding may indicate that the response is based on authoritative sources or accurate context interpretation, while a low degree of grounding may suggest potential hallucination, indicating error or irrelevance. In text generating systems that may use LLMs, SLMs, or similar models, measuring the degree of grounding may be essential for assessing the trustworthiness and reliability of generated outputs. Examples of the LLM may include Generative Pre-trained Transformer (GPT)-3, GPT-4, Bidirectional Encoder Representations from Transformers (BERT), or the like. Examples of the SLM may include DistilBERT, TinyBERT, or the like.

The degree of grounding, for each query-type, may be established based on the parameter values of the set of parameters. The set of parameters may include a brevity score, an entropy indicator, an inter-token delay, or a cosine similarity.

The processing circuitry 118 may be configured to generate a set of parameter values for the set of parameters based on the proposed query response. The set of parameter values may include a parameter value for each parameter of the set of parameters. Each parameter value may have a corresponding context in the detection of hallucination in the proposed query response. For example, the brevity score may indicate over-explanation or under explanation in the proposed query response. The over-explanation in the proposed query response may correspond to the presence of unnecessary details in the proposed query response. The presence of unnecessary details in the proposed query response may indicate plausible and made-up information by the text generating systems. Similarly, the under-explanation in the proposed query response may indicate vagueness in the proposed query response.

In another example, a relatively short inter-token delay for generation of tokens in a first set of tokens of the proposed query response may be indicative of relatively high confidence and accuracy in the proposed query response, whereas a relatively long inter-token delay may indicate uncertainty or difficulty in generating tokens of the first set of tokens, which can be associated with relatively lower accuracy and a probability of hallucination in the proposed query response. As used herein, the term ‘entropy’ refers to a quantitative measure of uncertainty or unpredictability associated with the first set of tokens of the proposed query response. In some other examples, a relatively low entropy value for the entropy indicator may reflect a sharply peaked probability distribution in the proposed query response, where one token may have a significantly higher probability than other tokens, signaling sufficient confidence and significant factual correctness. On the other hand, a relatively high entropy value for the entropy indicator may denote a more uniform probability spread across multiple tokens in the proposed query response, indicating uncertainty.

The storage element 106 may refer to any physical or virtual component configured to store data, instructions, or information in a retrievable format. The storage element 106 may include, but is not limited to, volatile memory (e.g., random access memory (RAM)), non-volatile memory (e.g., read-only memory (ROM), flash memory), magnetic storage (e.g., hard disk drives), optical storage (e.g., CDs, DVDs), solid-state drives (SSDs), or cloud-based storage systems. The storage element 106 may be local to the hallucination detection system 102 or remotely accessible by the server 104 over the communication network 116. The storage element 106 may be implemented as a single unit or distributed across multiple physical or logical locations. The storage element 106 may be configured to store parameter values, thresholds, weights, or any other type of data required for the operation of the hallucination detection system 102. In an example, the storage element 106 may store a parameter weight log 120, a hallucination threshold log 122, and a parameter threshold log 124.

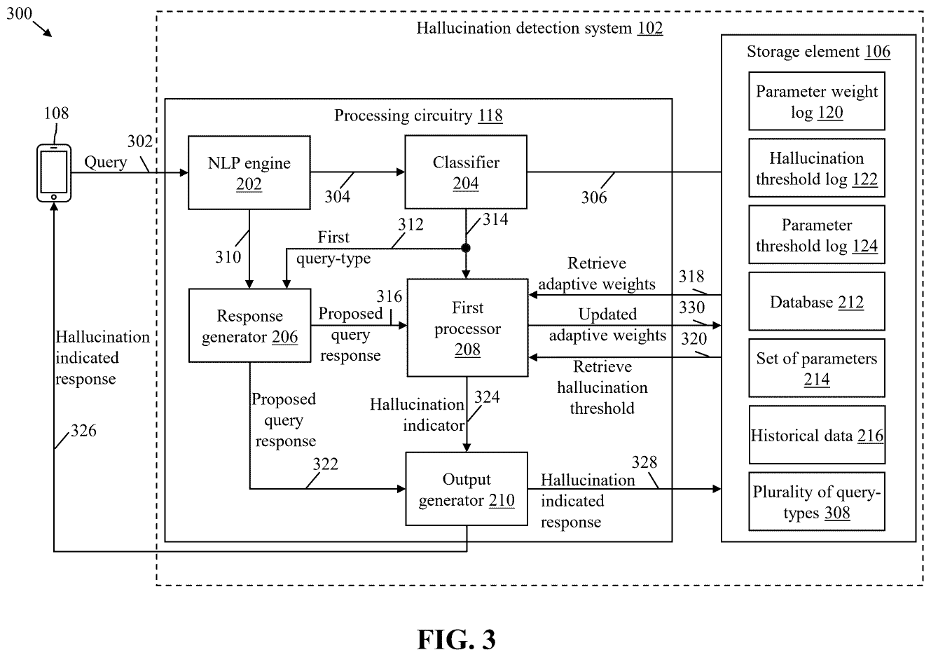

The parameter weight log 120 may refer to a log of adaptive weights associated with the set of parameters. For each query-type of the plurality of query-types, the set of parameters may be associated with a corresponding set of adaptive weights. Therefore, the parameter weight log 120 may include, for each query-type of the plurality of query-types, a set of adaptive weights for the set of parameters. In an example, for the first query-type, the set of parameters may be associated with a first set of adaptive weights. Similarly, for a second query-type, the set of parameters may be associated with a second set of adaptive weights. The set of adaptive weights of the set of parameters may be adjusted as described in conjunction with FIG. 3.

The processing circuitry 118 may assess the parameter weight log 120 to determine the first set of adaptive weights associated with the set of parameters for the first query-type. The processing circuitry 118 may determine the first set of adaptive weights based on the first query-type being associated with the first query. Subsequently, the processing circuitry 118 may determine a hallucination magnitude for the query based on the set of parameter values for the set of parameters and the first set of adaptive weights for the set of parameters for the first query-type. In an example, the hallucination magnitude may be determined based on a sum of product of parameter value and an adaptive weight of each parameter of the set of parameters. The hallucination magnitude may be indicative of a measure of hallucination that may be present in the proposed query response.

The processing circuitry 118 may be further configured to access the hallucination threshold log 122 to determine a hallucination threshold for the first query-type. The hallucination threshold log 122 may include a hallucination threshold for each query-type of the plurality of query-types. The hallucination threshold of a given query-type may be indicative of a minimum hallucination magnitude that may indicate presence of hallucination in a proposed query response for a query with the given query-type. The hallucination threshold of each query-type may be dynamic and may be updated based on a set of adaptive thresholds associated with the set of parameters for the query-type. Notably, an adaptive threshold of each parameter of the set of parameters may be dynamic. Hence, the hallucination threshold associated with each query-type may also be dynamic. In some embodiments, the hallucination threshold may be accessed from the hallucination threshold log 122. In some embodiments, the hallucination threshold may be determined upon reception of the query and based on a determination of the set of parameter values for the set of parameters. For determining the hallucination threshold for the first query-type, the processing circuitry 118 may access the set of adaptive thresholds of the set of parameters from the parameter threshold log 124. The parameter threshold log 124 may include, for each query-type, an adaptive threshold of each parameter of the set of parameters. The processing circuitry 118 may update the parameter threshold log 124 to reflect a change in an adaptive threshold of a parameter of the set of parameters for a query-type of the plurality of query-types.

The processing circuitry 118 may be further configured to determine a hallucination indicator based on the hallucination magnitude and the hallucination threshold. The hallucination indicator may be indicative of the presence or absence of hallucination in the proposed query response. The hallucination indicator may be generated based on a comparison of the hallucination magnitude and the hallucination threshold. The hallucination indicator may have a positive state (namely, a positive value) based on the hallucination magnitude being greater than the hallucination threshold. The positive state (namely, the positive value) of the hallucination indicator may indicate the presence of hallucination in the proposed query response. In other words, the hallucination indicator may indicate the presence of hallucination in the proposed query response based on the hallucination magnitude being greater than the hallucination threshold. Alternatively, the hallucination indicator may have a negative state based on the hallucination magnitude being less than the hallucination threshold. The negative state of the hallucination indicator may indicate the absence of hallucination in the proposed query response. In other words, the hallucination indicator may indicate the absence of hallucination in the proposed query response based on the hallucination magnitude being less than or equal to the hallucination threshold.

In some embodiments, only the hallucination indicator may be communicated to the user device 108. In some embodiments, the hallucination indicator may be communicated in combination with the proposed query response as a hallucination indicated response to the user device 108. Beneficially, based on the determination of the presence or absence of hallucination in the proposed query response before the proposed query response is provided as an output to the user device 108, allows for the detection of hallucination in the proposed query response in real-time. Therefore, the user of the user device 108 may be aware of whether an output of the query has a lack of grounding. This allows the user to make an informed decision regarding the use of information provided as the output of the query.

In some embodiments, based on the detection of hallucination in the proposed query response, the query may be reframed to be clearer, more specific, and unambiguous, which may aid in the generation of a response for the reframed query without hallucination.

In some embodiments, based on the detection that the proposed query response is hallucinated, the first processor 208 may, iteratively, apply corrective strategies and regenerate a portion of the proposed query response. Notably, an iterative correction of the hallucinated proposed query response may aid in the removal of hallucination from the proposed query response.

Having described the system environment 100 for implementation of the hallucination detection system 102, the description now moves towards a detailed description of the hallucination detection system 102.

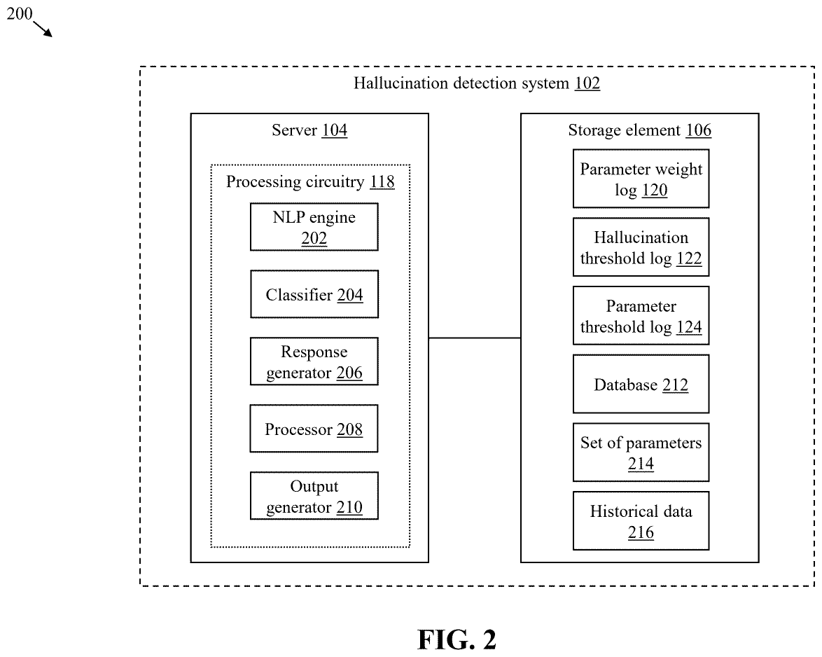

FIG. 2 is a block diagram 200 that illustrates the hallucination detection system 102, consistent with disclosed embodiments of the present disclosure. Referring to FIG. 2, the hallucination detection system 102 is shown to include the server 104 having the processing circuitry 118 and the storage element 106 coupled to the server 104. The processing circuitry 118 is shown to include a natural language processing (NLP) engine 202, a classifier 204, a response generator 206, a first processor 208, and an output generator 210.

The NLP engine 202 may include suitable logic, circuitry, interfaces, and/or code, executable by the circuitry, that may be configured to extract meaning, context, or intent associated with the query and the proposed query response. In an embodiment, the NLP engine 202 may access the query and the proposed query response. The NLP engine 202 may further analyze the query and the proposed query response. During analysis of the query, the NLP engine 202 may identify keywords within the query and apply parsing techniques to parse a set of query tokens of the query and subsequently determine the grammatical structure thereof. This parsing may help establish a context associated with the query, which in turn may support intent recognition for determining what the user is trying to achieve. Thus, the NLP engine 202 may be configured to extract the intent and the context of the query. The NLP engine 202 may then perform text processing on the query.

The text processing may transform the query into structured representations. During the text processing of the query, the NLP engine 202 may normalize the query. The normalization of the query may involve converting text to lowercase, removing punctuation, stopwords, numbers, and special characters, applying stemming or lemmatization, trimming extra spaces, ensuring unicode consistency, and optionally tokenizing the query into words. Upon normalization, the NLP engine 202 may perform tokenization on the normalized query. The NLP engine 202 may perform tokenization to split the query into words. Post text processing, the NLP engine 202 may perform vectorization and convert the vector of tokens into a numerical vector using an embedding method. In an embodiment, the vectorization may be performed by a transformer model, associated with the NLP engine 202, such as a Bidirectional Encoder Representations from Transformers (BERT) model. Thus, the NLP engine 202 may generate contextualized representations of the query. Similarly, the NLP engine 202 may perform the abovementioned operations for the proposed query response as well.

The classifier 204 may be coupled to the NLP engine 202. The classifier 204 may include suitable logic, circuitry, interfaces, and/or code, executable by the circuitry, that may be configured to determine the first query-type of the query. Post vectorization, the classifier 204 may be configured to receive, from the NLP engine 202, the contextualized representation of the query, for example, in a numerical vector form of the query. The numerical vector form may represent various features of the query that capture the meaning, structure, or statistical properties of the query. Examples of the features may include, but are not limited to, word frequency (namely, term counts), semantic relationships between words (for example, context, similarity), or the like. The classifier 204 may be further configured to compare the numerical vector against a learned pattern or categories. The learned pattern and categories may be stored in the storage element 106. The learned pattern and categories may include pre-defined intents and contexts for each query-type of the plurality of query-types. Such patterns and categories may be learned based on a reinforcement learning process executed by utilizing historical data associated with hallucination detection as well as training data pertaining to hallucination detection. The classifier 204 may compare the contextualized representations of the query against the learned pattern and categories stored in the storage element 106. Based on the comparison, the classifier 204 may be further configured to determine the first query-type associated with the query. As described above, the first query-type may be one of the plurality of query-types, including the factual query-type, the procedural query-type, the creative query-type, the mythical query-type, or the unknown query-type.

The response generator 206 may be communicatively coupled to the NLP engine 202 and the classifier 204. The response generator 206 may include suitable logic, circuitry, interfaces, and/or code, executable by the circuitry, that may be configured to generate the proposed query response. The response generator 206 may be further configured to receive the query, the intent, and the context associated with the query from the NLP engine 202. The response generator 206 may be further configured to receive the first query-type of the query from the classifier 204. In an embodiment, the response generator 206 may utilize the text generating system to generate the proposed query response for the query.

As discussed above, despite the generative capabilities of text generating system, the proposed query response may not always be guaranteed to be accurate or verifiable. One of the reasons may include the generation of the proposed query response based on statistical patterns learned from a wide range of internet-scale data, rather than referencing a live database or ground-truth-verified repository at the time of generation of the proposed query response. However, for the query, the ground truth response may exist that may correspond to a known, validated outcome and may serve as an attribute to be used for determination of grounding or hallucination in the proposed query response. For example, a set of tokens in a ground truth response may be used for determination of a brevity score associated with a proposed query response.

Each query-type of the plurality of query-types may be associated with a subject area. The subject area may refer to a broad domain to which the query-type may belong. A ground truth response for a query may be tied to a subject area associated with a corresponding query-type. That is to say, the ground truth response for the query may be associated with the subject area associated with the query-type of the query. For example, based on the first query-type corresponding to the factual query-type, the subject area may typically fall under, for instance, an objective, knowledge-based domain having verifiable and concrete information. The subject area may correspond to example domains of geography, history, science, or the like. Similarly, based on the first query-type corresponding to the mythical query-type, the subject area may pertain to a domain having imaginary, supernatural, or culturally symbolic content, often without objective truth. In such a scenario, the subject area may correspond to example domains of mythology, folklore and legends, astrology, or the like.

Similarly, based on the first query-type belonging to the creative query-type, the subject area may pertain to example domains of creativity and novelty, which involves generation of stories, poems, innovations, or content often driven by imagination. The subject area may correspond to domains of storytelling, poetry, creative design, or the like. Similarly, based on the first query-type corresponding to the procedural query-type, the subject area may pertain to example domains of generation of step-by-step instructions or process explanations, often involving logical sequencing. In such a scenario, the subject area may pertain to fields involving programming, how-to guides, or the like.

Therefore, identifying a subject area for a query-type may be significant for determining a corresponding ground truth response. A database 212 stored in the storage element 106 may be configured to store trusted datasets associated with a subject area for each query-type of the plurality of query-types. In an embodiment, the first processor 208 may be further configured to create the database 212. To generate the database 212, the first processor 208 may be configured to collect data from trusted data sources, such as public application programming interface (APIs), for example, accessing product reviews from an e-commerce platform via the API of the e-commerce platform, retrieving financial data (e.g., stock prices, historical trades) from a financial services API, collecting weather data via APIs associated with meteorological services, logs (for example, chat logs, server logs, request logs, search history, or the like), extracting data from websites using bots or tools, real-time input, or accessing any other sources of data relevant or related to the query. The collected data may be further preprocessed to remove any noise, duplicates, or irrelevant entries. The preprocessed data may be further normalized, and a contextualized representation of the preprocessed data may be generated. The contextualized representation of the preprocessed data may include keywords, which may serve as salient indicators for identifying a corresponding subject area. The contextualized representation of the preprocessed data may be further analyzed and mapped to a corresponding subject area by utilizing various mapping techniques. Thus, the database 212 may store the plurality of query-types, the subject area for each query-type of the plurality of query-type, and the contextualized representation of the preprocessed data for the subject area of each query-type of the plurality of query-type. That is to say that, the database 212 may be associated with a subject area of the first query-type. The processing circuitry 118 may be further configured to store the database 212 in the storage element 106.

The first processor 208 may be communicatively coupled to the classifier 204 and the response generator 206. The first processor 208 may include suitable logic, circuitry, interfaces, and/or code, executable by the circuitry, that may be configured to execute one or more operations for generation of the hallucination magnitude in the proposed query response. The first processor 208 may be further configured to retrieve the first query-type from the classifier 204 and the proposed query response from the response generator 206.

To ensure the reliability of the proposed query response, the first processor 208 may be further configured to establish the degree of grounding for the proposed query response. To establish the degree of grounding, the first processor 208 may be configured to generate the set of parameter values for the set of parameters (hereinafter referred to as “the set of parameters 214”) stored in the storage element 106. The set of parameter values may be collectively indicative of the degree of grounding in the proposed query response. That is to say, the first processor 208 may be configured to generate a first parameter value for the brevity score, a second parameter value for the entropy indicator, a third parameter value for the inter-token delay, and a fourth parameter value for the cosine similarity. Thus, the first parameter value, the second parameter value, the third parameter value, and the fourth parameter value may, collectively, constitute the set of parameter values. As described above, the set of parameters may include the brevity score, the entropy indicator, the inter-token delay, or the cosine similarity. In some other embodiments, the set of parameters may include additional or different parameters that may be used as indicators of the presence or absence of hallucination in the proposed query response.

The brevity score may correspond to a ratio of a first count of tokens in the first set of tokens associated with the proposed query response to a second count of tokens in a second set of tokens associated with the ground truth response pertaining to the query. In other words, the first parameter value of the brevity score is generated by utilizing the first count of tokens in the first set of tokens pertaining to the proposed query response and the second count of tokens in the second set of tokens pertaining to the ground truth response for the query. In an embodiment, based on the query being associated with the first query-type, the processing circuitry 118 may be further configured to identify a subject area associated with the first query-type. The processing circuitry 118 may be further configured to generate the ground truth response for the query based on the subject area associated with the first query-type and by utilizing the database 212.

Thus, to generate the first parameter value for the brevity score, the first processor 208 may utilize the first count of tokens in the first set of tokens pertaining to the proposed query response and the second count of tokens in the second set of tokens pertaining to the ground truth response.

The brevity score may be computed based on an equation (1) provided below:

$$Brevity score = \frac{First count of tokens in proposed query response}{Second count of tokens in ground truth response} \qquad ( 1 )$$

In an example, the query may be “When did world war 1 end?”, the ground truth response may be “World war 1 ended on Nov. 11, 1918”, and the proposed query response may be “World war 1 ended in 1919 after the Treaty of Versailles was signed.” In such an example, the first count of tokens may be 9 and the second count of tokens may be 12. Therefore, the brevity score may be 0.75. Also, the query may be associated with the factual query-type. An adaptive threshold for the brevity score for the factual query-type may be 0.9, which indicates that a minimum brevity score of a proposed query response for a query associated with the factual query-type should be 0.9. Therefore, the brevity score of the proposed query response “World war 1 ended in 1919 after the treaty of Versailles was signed.” being 0.75, which is less than the adaptive threshold 0.9, may indicate a high probability of presence of hallucination in the proposed query response “World war 1 ended in 1919 after the treaty of Versailles was signed.”

The entropy indicator may correspond to a measure of uncertainty associated with the proposed query response. The second parameter value of the entropy indicator is generated by utilizing information contribution of each token of the first set of tokens. For example, each token of the first set of tokens may be associated with a probability. The entropy indicator may measure how spread out these probabilities are. If many tokens have similar probabilities, the entropy indicator may be relatively high (indicating uncertainty). If one token has a relatively very high probability, the entropy indicator may be low (indicating certainty). Each token may contribute a certain amount of information. If each token contributes a meaningful amount of information, the entropy indicator may be relatively high. Conversely, the entropy indicator may be relatively low if each token contributes minimal new information.

The entropy indicator may be computed based on an equation (2) provided below:

$$H ( x ) = - \sum p ( xi ) log p ( xi ) \qquad ( 2 )$$

Where H (x) is entropy of a token ‘x’ and p (x) is probability of the token.

That is to say, the second parameter value for the entropy indicator may be generated by utilizing information contribution of each token of the first set of tokens.

In an example, the query may be “What is the capital of France?” and the proposed query response may be “The capital of France is Paris.” Here, the parameter value of the entropy indicator of the tokens the, capital, of, France, is, Paris may be 0.05, 0.1, 0.05, 0.1, 0.2, and 0.3, respectively.

The inter-token delay may correspond to time-interval between generation of two adjacent tokens in the first set of tokens. The third parameter value for the inter-token delay may be generated by utilizing a time-interval between the generation of two adjacent tokens in the first set of tokens. For the generation of each token in the proposed query response, a consistent time interval may be associated therewith. That is to say, the inter-token delay should be consistent. Thus, a sudden increase in inter-token delay for the generation of a token in the proposed query response may indicate computational uncertainty. The proposed query response, when generated based on such computational uncertainty, may further indicate that the generated proposed query response has hallucination therein. To detect hallucination based on the inter-token delay, inter-token delay divergence may be determined. The inter-token delay divergence may correspond to an extent of deviation between the maximum time taken by a token for the corresponding generation and the average time taken for the generation of all the tokens in the proposed query response. Thus, for determining the inter-token delay divergence, a difference between a maximum inter-token delay and the average inter-token delay may be calculated.

The inter-token delay may be computed based on an equation (3) provided below:

$$Inter - token delay = Maximum inter - token delay - Average inter - token delay \qquad ( 3 )$$

In an example, a delay between generations of a token 1 of the first set of tokens and a token 2 of the first set of tokens may be 100 microseconds (msec), which may be expected. A delay between generations of the token 2 and a token 3 of the first set of tokens may be 120 msec, which may also be expected. A delay between generations of the token 3 and a token 4 of the first set of tokens may be 150 msec, which may be indicative of an increase in inter-token delay and a potential uncertainty associated with the token 4. A delay between generations of the token 4 and a token 5 of the first set of tokens may be 3000 msec, which may be indicative of a significant and gradual increase in inter-token delay and a potential uncertainty associated with the token 5.

The cosine similarity may be indicative of semantic similarity between the proposed query response and the query. The fourth parameter value for the cosine similarity may be generated by utilizing a vector representation of the query and the proposed query response. For determining the cosine similarity, the proposed query response and the query may be represented as vectors.

The cosine similarity may be computed based on an equation (4) provided below:

$$Cosine similarity = \frac{{\sum }_{i = 1}^{n} {A}_{i} * {B}_{i}}{\sqrt{{\sum }_{i = 1}^{n} {A}_{i}^{2}} * \sqrt{{\sum }_{i = 1}^{n} {B}_{i}^{2}}} \qquad ( 4 )$$

where A and B are vector representations of the proposed query response and the actual query response, and Ai and Bi are individual components of the vector representations A and B, respectively.

In an example, the query may be “How to perform CPR on an adult?”. A vector representation of the query may be “[0.4, 0.3, 0.5, 0.1]”. The proposed query response may be a step-by-step process of performing CPR on an adult, a vector representation of the proposed query response may be “[0.5, 0.4, 0.6, 0.2]”. In the example, the Cosine Similarity=0.64/0.714× 0.9=0.64/0.6426≈0.996, which indicates that the proposed query response may be very similar and aligned with the query.

As described above, for each query-type, each parameter of the set of parameters 214 may be associated with a corresponding adaptive threshold. That is to say that, for each query-type, the set of parameters may be associated with a corresponding set of adaptive thresholds. For example, for the first query-type, the set of parameters may be associated with the first set of adaptive thresholds, whereas for a second query-type, the set of parameters may be associated with a second set of adaptive thresholds. In an example, for each query-type, each adaptive threshold, of the corresponding set of adaptive thresholds, may be defined within a threshold range bounded by a minimum adaptive threshold and a maximum adaptive threshold. The range for the adaptive threshold, for each query-type, may be different for each parameter of the set of parameters 214. For example, the first parameter value of the brevity score falling out of the range of a corresponding threshold range, may be indicative of a possibility of presence of hallucination in the proposed query response, where the brevity score falling below the minimum adaptive threshold may indicate under explanation and the brevity score being greater than the maximum adaptive threshold may indicate over explanation.

In an embodiment, the proposed query response may be overly explained, which may be indicated by the first count of tokens in the first set of tokens being significantly greater than the second count of tokens in the second set of tokens. In such an embodiment, the brevity score may exceed the corresponding maximum adaptive threshold. Similarly, based on the proposed query response being highly concise (for example, the first count of tokens in the proposed query response being less than the second count of tokens in the ground truth response), the brevity score may fall under a minimum adaptive threshold of the brevity score. Similarly, the parameter value of the brevity score being within the threshold range of the brevity score may indicate that the proposed query response may not be hallucinated. Thus, the first parameter value associated with the brevity score may indicate whether there may be a possibility of the proposed query response being hallucinated. The first parameter value in conjunction with the second, third, and fourth parameter values may be used to determine whether the proposed query response is hallucinated.

In some embodiments, for each query-type, the adaptive threshold of each parameter of the set of parameters may be a dynamic threshold value. In an example, for the factual query-type, adaptive thresholds for the parameters entropy indicator, cosine similarity, inter-token delay, and brevity score may be 0.4, 0.1, 150 msec, and 0.8, respectively. In another example, for the procedural query-type, adaptive thresholds for the parameters entropy indicator, cosine similarity, inter-token delay, and brevity score may be 0.3, 0.05, 100 msec, and 0.09, respectively. In another example, for the creative query-type, adaptive thresholds for the parameters entropy indicator, cosine similarity, inter-token delay, and brevity score may be 0.7, 0.3, 200 msec, and 0.5, respectively. In another example, for the mythical query-type, adaptive thresholds for the parameters entropy indicator, cosine similarity, inter-token delay, and brevity score may be 0.6, 0.2, 180 msec, and 0.6, respectively. In another example, for the unknown query-type, adaptive thresholds for the parameters entropy indicator, cosine similarity, inter-token delay, and brevity score may be 0.8, 0.4, 250 msec, and 0.4, respectively. For each query-type, the adaptive threshold for the parameter entropy indicator may be set to allow a maximum permissible parameter value for the entropy indicator. Similarly, for each query-type, the adaptive threshold for the parameter cosine similarity may be set to allow a maximum permissible parameter value for the cosine similarity. For each query-type, the adaptive threshold for the parameter inter token delay may be set to allow a maximum permissible parameter value for the inter token delay. For each query-type, the adaptive threshold for the parameter brevity score may be set to detect a minimum required parameter value for the brevity score.

In some embodiments, when the first query-type may be the factual query-type, the proposed query response should be definitive and accurate with minimal ambiguity. Additionally, high semantic alignment may be expected in the proposed query response, as the proposed query response should match the ground truth response associated with the query. Moreover, the proposed query response should be straightforward, which may imply quick and confident generation thereof. The proposed query response should correspond to a factual statement and should be direct and accurate without unnecessary elaboration. The abovementioned reasonings may be used for determination of the first set of adaptive thresholds for the set of parameters for the factual query-type.

In some embodiments, when the first query-type may be the procedural query-type, the proposed query response should have precision and structure with minimal uncertainty. Additionally, high consistency may be expected in the proposed query response, as the proposed query response should not diverge semantically. Moreover, the proposed query response should be predictable and should have a sequence. The proposed query response should not have over-explanation or vagueness, which may lead to errors. Hence, the response should be concise. The abovementioned reasonings may be used for determination of the first set of adaptive thresholds for the set of parameters for the procedural query-type.

In some embodiments, when the first query-type may be the creative query-type, the proposed query response should have high entropy indicative of flexibility and diversity. Additionally, the proposed query response may be thematically varied, which allows for poetic or imaginative expressions. Moreover, creativity may involve pauses for coherence, especially when generating longer narratives. Further, creative content often explores ideas, and brevity may vary based on context. The abovementioned reasonings may be used for the determination of the first set of adaptive thresholds for the set of parameters for the creative query-type.

In some embodiments, when the first query-type may be the mythical query-type, the proposed query response may be ambiguous or speculative. Additionally, multiple viewpoints for the generation of the proposed query response may be possible, which may lead to semantic variation. Moreover, the proposed query response may be speculative, and hence generation thereof may require reasoning pauses or contextual buildup. Notably, myths may require contextual elaboration but should not be overly verbose. The abovementioned reasonings may be used for the determination of the first set of adaptive thresholds for the set of parameters for the mythical query-type.

In some embodiments, when the first query-type may be the unknown query-type, the proposed query response may be uncertain, and the query itself may lack clear grounding. Additionally, multiple perspectives and interpretations may coexist, which may lead to higher variance. Also, responses may vary significantly, which may require extended generation time. Also, a count of tokens in each perspective of interpretation may vary without a definitive stance. The abovementioned reasonings may be used for the determination of the first set of adaptive thresholds for the set of parameters for the unknown query-type.

In an embodiment, the first set of adaptive thresholds, for the first query-type, may be generated based on historical data 216 stored in the storage element 106. The historical data 216 may include, for each query-type, a historical set of adaptive thresholds associated with the set of parameters 214 for each query-type, a learning rate associated with the set of parameters 214 for each query-type, a metric of historical false-positive hallucination indicators for each query-type, a metric of historical false-negative hallucination indicators for each query-type, or a first direction of correction associated with the historical set of adaptive thresholds. In some embodiments, the historical data 216 may further include historical proposed query responses generated for historical queries. Thus, the first processor 208 may be configured to generate the set of adaptive thresholds of the set of parameters 214 for the first query-type, based on the historical set of adaptive thresholds associated with the set of parameters 214 for the first query-type, the learning rate associated with the set of parameters 214 for the first query-type, a metric of historical false-positive hallucination indicators for the first query-type, a metric of historical false-negative hallucination indicators for the first query-type, or the first direction of correction associated with the historical set of adaptive thresholds.

The historical set of adaptive thresholds may refer to a previously recorded or observed set of threshold values that may have contributed to hallucination detection in historical proposed query responses.

The learning rate may correspond to a hyperparameter that controls a rate at which at least one of the historical set of adaptive thresholds should be updated/modified in response to an inaccurate detection of hallucination in a previously proposed query response stored in the storage element 106.

The metric of historical false-positive hallucination indicators may be indicative of number (alternatively, percentage) of times in history when a proposed query response is determined by the hallucination detection system 102 to be hallucinated, when the proposed query response may actually be non-hallucinated.

The metric of historical false-negative hallucination indicators may be indicative of number (alternatively, percentage) of times in history when a proposed query response is determined by the hallucination detection system 102 to be non-hallucinated, when the proposed query response may actually be hallucinated.

The first direction of correction associated with the historical set of adaptive thresholds may indicate whether an increase or decrease in at least one of the historical set of adaptive thresholds is required for the accurate determination of hallucination in subsequent detections of hallucination in proposed query responses. The first direction of correction may have a value of 1 to indicate a requirement of an increase in at least one of the historical set of adaptive thresholds, whereas the first direction of correction may have a value of −1 to indicate a requirement of a decrease in at least one of the historical set of adaptive thresholds.

In an embodiment, a cumulative metric of the historical false-negative hallucination indicators and the historical false-positive hallucination indicators, associated with the first query-type, may exceed a predetermined threshold. In such an embodiment, the first processor 208 may be configured to determine a requirement for adjusting at least one of the historical set of adaptive thresholds of the set of parameters for the first query-type. For the sake of brevity, it is assumed that a historical adaptive threshold of a first parameter of the set of parameters 214 for the first query-type may have to be adjusted. A first adaptive threshold for the first parameter may be generated by adjusting the historical adaptive threshold of the first parameter.

Thus, the first adaptive threshold for the first parameter of the set of parameters 214 may be computed based on equation (5) provided below:

$$T\_new = T\_old + α \times ( FP - FN ) \times S 1 \qquad ( 5 )$$

where T_new is the first adaptive threshold for the first parameter of the set of parameters 214, T_old is a historical threshold for the first parameter of the set of parameters 214, α is the learning rate associated with the first parameter of the set of parameters 214 for the first query-type, FP is the metric of historical false-positive hallucination indicators, FN is the metric of historical false-negative hallucination indicators, and S1 is the direction correction associated with the historical set of adaptive thresholds of the set of parameters for the first query-type, S1 may have a value of ‘+1’ based on a previous detection of hallucination being false negative, and S1 may have a value of ‘−1’ based on the previous detection of hallucination being false positive. In some embodiments, the metric of historical false-positive hallucination indicators and the metric of historical false-negative hallucination indicators may be stored in the storage element 106. The first processor 208 may be configured to retrieve the metric of historical false-positive hallucination indicators and the metric of historical false-negative hallucination indicators from the storage element 106. In some embodiments, the metric of historical false-positive hallucination indicators and the metric of historical false-negative hallucination indicators may be generated by the first processor 208 based on user feedback received via the plurality of user devices 108-114.

Similarly, an adaptive threshold for each parameter of the set of parameters for the first query-type may be determined, and subsequently, a first set of adaptive thresholds of the set of parameters for the first query-type may be generated by the first processor 208.

An adaptive threshold for each parameter of the set of parameters 214 may be computed by utilizing equation (5) as described above.

Upon the generation of the first set of adaptive thresholds for the set of parameters 214 for the first query-type, the hallucination threshold for the first query-type may be determined based on the first set of adaptive thresholds.

The hallucination threshold, for the first query-type, may be determined based on equation (6) provided below:

$$Hallucination threshold = {\sum }_{i = 1}^{n} {Ti}^{new} \qquad ( 6 )$$

where Ti^{new} corresponds to a sum of adaptive thresholds in the first set of adaptive thresholds for the set of parameters 214 for the first query-type.

The first processor 208 may be further configured to store/update the hallucination threshold for the first query-type in the hallucination threshold log 122. The hallucination threshold log 122 may include a hallucination threshold for each query-type of the plurality of query-types. The first processor 208 may be further configured to store the first set of adaptive thresholds in the parameter threshold log 124.

Although the generation of the hallucination threshold is described for the first query-type, the scope of the present disclosure is not limited to it. In numerous other embodiments, the hallucination threshold for each query-type of the plurality of query-types may be generated in a similar manner.

In an embodiment, the first processor 208 may be further configured to analyze the historical proposed query responses. Based on the analysis, the first processor 208 may determine that the cumulative metric of historical false-positive hallucination indicators and the historical false-negative hallucination indicators for the first query-type may exceed the predefined threshold. Based on the cumulative metric of the historical false-positive hallucination indicators and the historical false-negative hallucination indicators for the first query-type exceeding the predefined threshold, the first processor 208 may be further configured to determine a requirement to adjust the hallucination threshold for the first query-type. To adjust the hallucination threshold, the first processor 208 may be further configured to adjust the first set of adaptive thresholds. That is to say, the first processor 208 may be further configured to generate a new set of adaptive thresholds based on the first set of adaptive thresholds. A new adaptive threshold for each parameter of the set of parameters 214 for the first query-type may be generated by utilizing equation (5). The first processor 208 may be further configured to store the first set of adaptive thresholds in the historical data 216 and the new set of adaptive thresholds in the parameter threshold log 124. The first processor 208 may be further configured to adjust the hallucination threshold based on the new set of adaptive thresholds. That is to say, a new hallucination threshold may be generated. In an embodiment, the new hallucination threshold may be generated by utilizing equation (6).

Although generation and adjustment of the hallucination threshold is described for the first query-type, the scope of the present disclosure is not limited to it. In numerous other embodiments, the first processor 208 may be configured to generate and adjust the hallucination threshold for any other query-type (for example, a second query-type) of the plurality of query-types as described herein.

The first processor 208 may be further configured to use the hallucination threshold for the first query-type to determine the hallucination magnitude for the proposed query response based on the set of parameter values and the first set of adaptive weights associated with the set of parameters 214. The first processor 208 may determine the hallucination magnitude for the proposed query response based on an equation (7) provided below:

$$Hallucination magnitude = ( W 1 * P 1 ) + ( W 2 * P 2 ) + ( W 3 * P 3 ) + ( W 4 * P 4 ) \qquad ( 7 )$$

where W1 and P1 correspond to a first adaptive weight and the first parameter value, respectively, of the parameter brevity score, W2 and P2 correspond to a second adaptive weight and the second parameter value, respectively, of the parameter entropy indicator, W3 and P3 correspond to a third adaptive weight and the third parameter value, respectively, of the parameter inter-token delay, and W4 and P4 correspond to a fourth adaptive weight and the fourth parameter value, respectively, of the parameter cosine similarity.

The first adaptive weight, the second adaptive weight, the third adaptive weight, and the fourth adaptive weight, collectively, form the first set of adaptive weights for the set of parameters for the first query-type. As described previously, the parameter weight log 120 may store the first set of adaptive weights for the set of parameters for each query-type of the plurality of query-types. The set of adaptive weights for the set of parameters for each query-type may be adjusted to optimize the detection of the presence or absence of hallucination in proposed query responses. The adjustment in the first set of adaptive weights of the set of parameters for each query-type is described in detail in conjunction with FIG. 3.

The first processor 208 may be further configured to retrieve the hallucination threshold for the first query-type from the hallucination threshold log 122. The first processor 208 may be further configured to generate the hallucination indicator for the proposed query response, based on the hallucination magnitude and the hallucination threshold associated with the first query-type. In an embodiment, the hallucination indicator may indicate the presence of hallucination in the proposed query response based on the hallucination magnitude being greater than the hallucination threshold. In some embodiments, the hallucination indicator may indicate the absence of hallucination in the proposed query response based on the hallucination magnitude being less than the hallucination threshold.

The output generator 210 may be communicatively coupled to the first processor 208 and the communication network 116. The output generator 210 may include suitable logic, circuitry, interfaces, and/or code, executable by the circuitry, that may be configured to execute one or more operations for generation of the hallucination indicated response. The output generator 210 may be configured to receive the proposed query response and the hallucination indicator. The output generator 210 may be further configured to generate the hallucination indicated response based on the proposed query response and the hallucination indicator. The hallucination indicated response may correspond to a response or an output that includes the proposed query response and the hallucination indicator indicative of the presence or absence of hallucination in the proposed query response. The output generator 210 may be further configured to communicate the hallucination indicated response to the user device 108 via the communication network 116.

Having described the hallucination detection system 102 in detail, the description now moves towards a discussion of an implementation of the hallucination detection system 102.

FIG. 3 depicts a schematic diagram 300 that illustrates an implementation of the hallucination detection system 102, consistent with disclosed embodiments of the present disclosure.

As described previously, the hallucination detection system 102 includes the server 104 (shown in FIGS. 1 and 2) having the processing circuitry 118 and the storage element 106. The processing circuitry 118 may be associated with the storage element 106. The processing circuitry 118 may include the NLP engine 202, the classifier 204, the response generator 206, the first processor 208, and the output generator 210. Referring to FIG. 3, at 302, the NLP engine 202 may be configured to receive the query from a user device (for example, the user device 108) via the communication network 116. It is assumed herein that the hallucination detection system 102 may be integrated with the text generating system and hence, may be capable of generating the proposed query response.

The NLP engine 202 may be further configured to parse the set of query tokens associated with the query. The parsing of the set of query tokens may be performed to separate each query token from the set of query tokens. The NLP engine 202 may be further configured to determine a contextual intent of each query token of the set of tokens. The contextual intent may be determined based on inter-token relationships in the set of query tokens, a sequence of query tokens in the set of query tokens, and a meaning and usage context of each query token of the set of query tokens. The contextual intent of the query may be determined by analyzing each query token of the set of query tokens of the query to understand its specific meaning, role, and purpose within the overall context of the query. The NLP engine 202 may be further configured to extract metadata of the query. The metadata may include a user device identifier, which may be a source of the query, time, and/or place of origin associated with the query. Subsequently, the NLP engine 202 may be further configured to analyze the query based on the contextual intent of each token of the first set of tokens and the metadata.

At 304, the classifier 204 may be configured to receive the query and the metadata associated therewith from the NLP engine 202. At 306, the classifier 204 may be further configured to retrieve a plurality of pre-defined intents and contexts, associated with the plurality of query-types, stored in the storage element 106. Hereinafter, the plurality of query-types may be referred to as “the plurality of query-types 308”. The classifier 204 may be further configured to map the intent and the context associated with the query with the retrieved pre-defined intents and contexts associated with the plurality of query-types 308 and classify a query-type of the query as the first query-type based on the intent and context of the query being a match to a pre-defined intent and context associated with the first query-type. In some embodiments, the classifier 204 may include a machine learning model that may be trained on intents and contexts associated with the historical queries, responses for the historical queries, and query-types associated with each of the historical queries. Additionally, the machine learning model of the classifier 204 may be trained based on a pre-defined set of intents and contexts associated with a pre-defined set of queries and query-types associated with each of the pre-defined set of queries.

In an embodiment, the classifier 204 may determine that the context and intent of the query may not match any of the pre-defined intents and contexts for the plurality of queries. Thus, the classifier 204 may determine an absence of a query-type for the query in the plurality of query-types 308. In such an embodiment, the classifier 204 may be further configured to define a new intent and context that may pertain to the query. The classifier 204 may be further configured to associate the unknown query-type with the new intents and context. At 306, the classifier 204 may be further configured to store the new intent and context for the unknown query-type in the storage element 106.

At 310, the response generator 206 may further retrieve the query and the intent and context associated with the query from the NLP engine 202. At 312, the response generator 206 may further retrieve the first query-type of the query from the classifier 204. The response generator 206 may further generate the proposed query response for the query based on the intent and context, and the first query-type. The response generator 206 may determine the subject area associated with the query based on the intent and context of the query. Based on the subject area, the response generator 206 may generate the proposed query response by utilizing the database 212.

At 314, the first processor 208 may be further configured to receive the first query-type associated with the query from the classifier 204. At 316, the first processor 208 may be further configured to receive the proposed query response from the response generator 206. The first processor 208 may be further configured to determine the set of parameter values for the set of parameters as described throughout the description.

At 318, the first processor 208 may receive, for the first query-type, the first set of adaptive weights from the parameter weight log 120. The first processor 208 may be further configured to determine the hallucination magnitude based on the set of parameter values and the first set of adaptive weights. The hallucination magnitude may be determined by utilizing equation (7). At 320, the first processor 208 may be further configured to retrieve the hallucination threshold for the first query-type from the hallucination threshold log 122. The first processor 208 may be further configured to generate the hallucination indicator based on the hallucination magnitude and the hallucination threshold associated with the first query-type. The first processor 208 may be configured to compare the hallucination magnitude with the hallucination threshold for the first query-type. Based on the hallucination magnitude being greater than the hallucination threshold for the first query-type, the proposed query response may have the presence of hallucination. Alternatively, based on the hallucination magnitude being less than or equal to the hallucination threshold for the first query-type, the proposed query response may have the absence of hallucination.

In some embodiments, for each query-type, the adaptive weight of each parameter of the set of parameters may be a dynamic weight. In an example, for the factual query-type, adaptive weights for the parameters entropy indicator, cosine similarity, inter-token delay, and brevity score may be 0.4, 0.3, 0.2, and 0.1, respectively. In another example, for the procedural query-type, adaptive weights for the parameters entropy indicator, cosine similarity, inter-token delay, and brevity score may be 0.3, 0.2, 0.3, and 0.2, respectively. In another example, for the creative query-type, adaptive weights for the parameters entropy indicator, cosine similarity, inter-token delay, and brevity score may be 0.2, 0.3, 0.2, and 0.3, respectively. In another example, for the mythical query-type, adaptive weights for the parameters entropy indicator, cosine similarity, inter-token delay, and brevity score may be 0.2, 0.2, 0.3, and 0.3, respectively. In another example, for the unknown query-type, adaptive weights for the parameters entropy indicator, cosine similarity, inter-token delay, and brevity score may be 0.225, 0.25, 0.25, and 0.25, respectively.

At 322, the output generator 210 may be further configured to receive the proposed query response from the response generator 206. At 324, the output generator 210 may be further configured to receive the hallucination indicator from the first processor 208. The output generator 210 may be further configured to generate the hallucination indicated response based on the proposed query response and the hallucination indicator. The hallucination indicated response may include the proposed query response generated for the query and the hallucination indicator. At 326, the output generator 210 may be further configured to communicate the hallucination indicated response to the user device 108. At 328, the output generator 210 may be further configured to store the hallucinated indicated response into the storage element 106. In an embodiment, the output generator 210 may store the hallucinated indicated response in the historical data 216 for further analysis.

In some embodiments, the first processor 208 may be further configured to compare the hallucination indicator with an actual hallucination state associated with the proposed query response. The actual hallucination state may indicate whether hallucination is truly present or absent in the proposed query response. That is to say, the actual hallucination state may indicate whether the proposed query response is actually hallucinated. In some embodiments, the hallucination indicator may match the actual hallucination state associated with the proposed query response. However, in some embodiments, the hallucinator indicator may not match the actual hallucination state of the proposed query response. In one instance, the hallucination indicator may be indicative of the proposed query response being hallucinated, however, the actual hallucination state may be indicative of the proposed query response not being hallucinated. In such an instance, the hallucination indicator may correspond to a false-positive hallucination indicator. In another instance, the hallucinator indicator may be indicative of the proposed query response being non-hallucinated, however, the actual hallucination state may be indicative of the proposed query response being hallucinated. In such an instance, the hallucination indicator may correspond to the false-negative hallucination indicator. Throughout the description, the presence of hallucination in the proposed query response corresponds to the proposed query response being hallucinated, whereas the absence of hallucination in the proposed query response corresponds to the proposed query response being non-hallucinated.

Thus, the first processor 208 may be configured to determine whether the hallucination indicator corresponds to the false-positive hallucination indicator or the false-negative hallucination indicator.

In embodiments, when the hallucinator indicator may not match the actual hallucination state of the proposed query response, the first processor 208 may be further configured to determine a requirement of adjusting the first set of adaptive weights associated with the set of parameters 214 for the first query-type. In an embodiment, the first processor 208 may be further configured to retrieve, from the historical data 216, the metric of historical false-positive hallucination indicators associated with the first query-type and the metric of historical false-negative hallucination indicators associated with the first query-type. Based on the cumulative metric of the historical false-negative hallucination indicators and the historical false-positive hallucination indicators exceeding the predefined threshold, the first processor 208 may be further configured to generate a new set of adaptive weights associated with the set of parameters 214 for the first query-type. The new set of adaptive weights may be generated by adjusting the adaptive weight of at least one parameter of the set of parameters for the first query-type. The first processor 208 may be configured to generate the new adaptive weights based on the first set of adaptive weights, the hallucination indicator, the actual hallucination state, the pre-defined learning rate for the set of parameters 214, or a second direction of correction associated with the first set of adaptive weights.

Thus, for the first query-type, a new adaptive weight for a first parameter of the set of parameters 214 may be computed based on equation (8) provided below:

$${Wi}^{new} = {Wi}^{old} + α \times ( {E}_{actual} - {E}_{predicted} ) \times ( S 2 ) \qquad ( 8 )$$

where Wi^{new} is a new adaptive weight for the first parameter of the set of parameters 214, Wi^{old} is a historical weight, of the first set of adaptive weights, for the first parameter of the set of parameters 214, α is the learning rate associated with the set of parameters 214 for the first query-type, E_{actual} is the actual hallucination state of the proposed query response and correspond to ‘1’ based on the proposed query response being actually hallucinated, or ‘0’ based on the proposed query response actually being non-hallucinated, E_{predicted} denotes the hallucination indicator and corresponds to 1 based on detection the presence of hallucination in the proposed query response or 0 based on detection of the absence of hallucination in the proposed query response by the first processor 208, S2 corresponds to the direction of the correction for at least one of the first set of adaptive weights of the set of parameters 214. Additionally, S2 may have a value of ‘+1’ based on a requirement of an increase in the adaptive weight of the first parameter for the first query-type, whereas S2 may have a value of ‘−1’ based on a requirement of a decrease in the adaptive weight of the first parameter for the first query-type. Although generation of the new adaptive weight is described herein for the first parameter, adaptive weight for each parameter of the set of parameters 214 for each query-type of the plurality of query-types may be computed in a similar manner by utilizing equation (8).

Upon generation of the new set of adaptive weights, the new set of adaptive weights may be normalized to ensure that the sum of adaptive weights of the new set of adaptive weights equals ‘1’. The new adaptive weight for the first parameter may be normalized based on equation (9) provided below:

$${Wi}_{normalized} = {Wi}_{new} / {\sum }_{i = 1}^{n} {Wj}^{new} \qquad ( 9 )$$

where Wi_{new} is the updated adaptive weight for the first parameter (e.g., the entropy indicator, the cosine similarity, the inter-token delay, the brevity score), Wj^{new} is a sum of each adaptive weight in the new set of adaptive parameters, Wi_{normalized} is the final, normalized weight for the first parameter, which ensures that the sum of all weights equals 1. Similarly, new adaptive weights of other parameters of the set of parameters of the first query-type may be generated.

At 330, the first processor 208 may be further configured to store the new set of adaptive weights in the parameter weight log 120. Although it is described that the first set of adaptive weights is updated/adjusted based on the cumulative metric of the historical false-negative hallucination indicators and the historical false-positive hallucination indicators exceeding the predefined threshold, the scope of the present disclosure is not limited to it. In numerous other embodiments, the first set of adaptive weights may be updated periodically or based on an input provided via the user device 108.

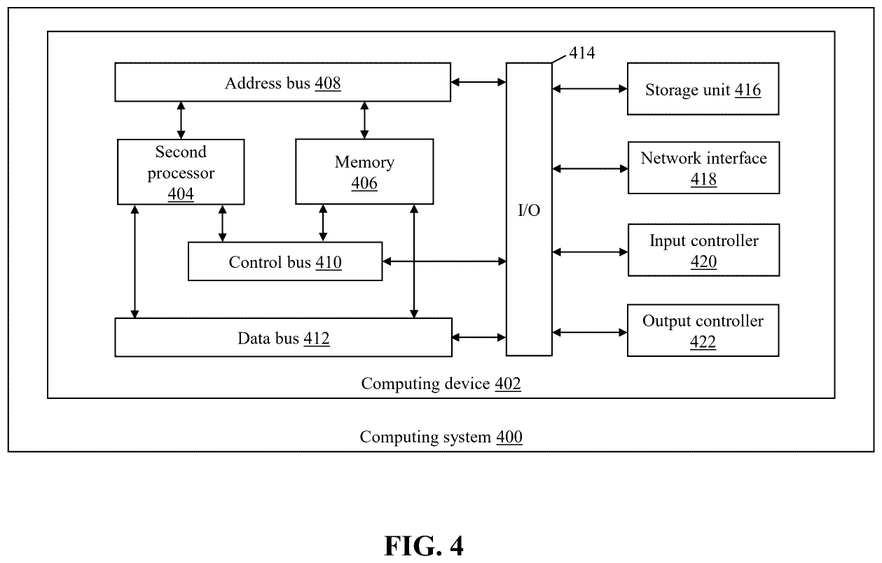

FIG. 4 shows an example computing system 400 for carrying out the methods of the present disclosure, consistent with disclosed embodiments of the present disclosure. Specifically, FIG. 4 shows a block diagram of an embodiment of the computing system 400 according to example embodiments of the present disclosure.

The computing system 400 may be configured to perform any of the operations disclosed herein. The computing system 400 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 400 is a distributed system configured to function using multiple computing machines interconnected via a data network or bus system.

The computing system 400 includes computing devices (such as a computing device 402). The computing device 402 includes one or more processors (such as a second processor 404) and a memory 406. The second processor 404 may be any general-purpose processor(s) configured to execute a set of instructions. For example, the second processor 404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the second processor 404 may be multiple processing units, a single processing core, multiple processing cores, special purpose processing cores, co-processors, or any combination thereof. The second processor 404 may be communicatively coupled to the memory 406 via an address bus 408, a control bus 410, and a data bus 412.

The memory 406 may include non-volatile memories such as a read-only memory (ROM), a programable read-only memory (PROM), an erasable programmable read-only memory (EPROM), a flash memory, or any other device capable of storing program instructions or data with or without applied power. The memory 406 may also include volatile memories, such as a random-access-memory (RAM), a static random-access-memory (SRAM), a dynamic random-access-memory (DRAM), and a synchronous dynamic random-access-memory (SDRAM). The memory 406 may include single or multiple memory modules. While the memory 406 is depicted as part of the computing device 402, a person skilled in the art will recognize that the memory 406 can be separate from the computing device 402.

The memory 406 may store information that can be accessed by the second processor 404. For instance, the memory 406 (e.g., one or more non-transitory computer-readable storage mediums, memory devices) may include computer-readable instructions (not shown) that can be executed by the second processor 404. The computer-readable instructions may be software written in any suitable programming language or may be implemented in hardware. Additionally, or alternatively, the computer-readable instructions may be executed in logically and/or virtually separate threads on the second processor 404. For example, the memory 406 may store instructions (not shown) that when executed by the second processor 404 cause the second processor 404 to perform operations such as any of the operations and functions for which the computing system 400 is configured, as described herein. Additionally, or alternatively, the memory 406 may store data (not shown) that can be obtained, received, accessed, written, manipulated, created, and/or stored. The data can include, for instance, the data and/or information described herein in relation to FIGS. 1-3. In some implementations, the computing device 402 may obtain from and/or store data in one or more memory device(s) that are remote from the computing system 400.

The computing device 402 may further include an input/output (I/O) interface 414 communicatively coupled to the address bus 408, the control bus 410, and the data bus 412. The data bus 412 may include a plurality of tunnels that may support communication in the hallucination detection system 102. The I/O interface 414 is configured to couple to one or more external devices (e.g., to receive and send data from/to one or more external devices). Such external devices, along with the various internal devices, may also be known as peripheral devices. The I/O interface 414 may include both electrical and physical connections for operably coupling the various peripheral devices to the computing device 402. The I/O interface 414 may be configured to communicate data, addresses, and control signals between the peripheral devices and the computing device 402. The I/O interface 414 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 414 is configured to implement only one interface or bus technology. Alternatively, the I/O interface 414 is configured to implement multiple interfaces or bus technologies. The I/O interface 414 may include one or more buffers for buffering transmissions between one or more external devices, internal devices, the computing device 402, or the second processor 404. The I/O interface 414 may couple the computing device 402 to various input devices, including mice, touch screens, scanners, biometric readers, electronic digitizers, sensors, receivers, touchpads, trackballs, cameras, microphones, keyboards, any other pointing devices, or any combinations thereof. The I/O interface 414 may couple the computing device 402 to various output devices, including video displays, speakers, printers, projectors, tactile feedback devices, automation control, robotic components, actuators, motors, fans, solenoids, valves, pumps, transmitters, signal emitters, lights, and so forth.

The computing system 400 may further include a storage unit 416, a network interface 418, an input controller 420, and an output controller 422. The storage unit 416, the network interface 418, the input controller 420, and the output controller 422 are communicatively coupled to the central control unit (e.g., the memory 406, the address bus 408, the control bus 410, and the data bus 412) via the I/O interface 414. The network interface 418 communicatively couples the computing system 400 to one or more networks such as wide area networks (WAN), local area networks (LAN), intranets, the Internet, wireless access networks, wired networks, mobile networks, telephone networks, optical networks, or combinations thereof. The network interface 418 may facilitate communication with packet-switched networks or circuit-switched networks which use any topology and may use any communication protocol. Communication links within the network may involve various digital or analog communication media, such as fiber optic cables, free-space optics, waveguides, electrical conductors, wireless links, antennas, radio-frequency communications, and so forth.

The storage unit 416 is a computer-readable medium, preferably a non-transitory computer-readable medium, comprising one or more programs, the one or more programs comprising instructions which when executed by the second processor 404 cause the computing system 400 to perform the method steps of the present disclosure. Alternatively, the storage unit 416 is a transitory computer-readable medium. The storage unit 416 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 416 stores one or more operating systems, application programs, program modules, data, or any other information. The storage unit 416 is part of the computing device 402. Alternatively, the storage unit 416 is part of one or more other computing machines that are in communication with the computing device 402, such as servers, database servers, cloud storage, network attached storage, and so forth.

The input controller 420 may include suitable logic, circuitry, interfaces, and/or code, executable by the circuitry, that may be configured to control one or more input devices that may be configured to receive an input for the hallucination detection system 102. The output controller 422 may include suitable logic, circuitry, interfaces, and/or code, executable by the circuitry, that may be configured to control one or more output devices that may be configured to render/output the outcome of the operation executed to process the received input.

In some embodiments, a computer-readable medium is disclosed. The computer-readable medium include instructions that, when executed by the processing circuitry 118 of the computing system 400, cause the computing system 400 to perform a method for detection of hallucination in the proposed query response for the query, the method comprises accessing the query. The method further includes determining the first query-type associated with the query. The method further includes accessing the proposed query response for the query. The method further includes generating, based on the proposed query response, the set of parameter values for the set of parameters. The set of parameter values is indicative of the degree of grounding associated with the proposed query response. The method further includes determining, based on the set of parameter values and the first set of adaptive weights associated with the set of parameters, a hallucination magnitude for the proposed query response. The method further includes generating, based on the hallucination magnitude and the hallucination threshold associated with the first query-type, a hallucination indicator for the proposed query response.

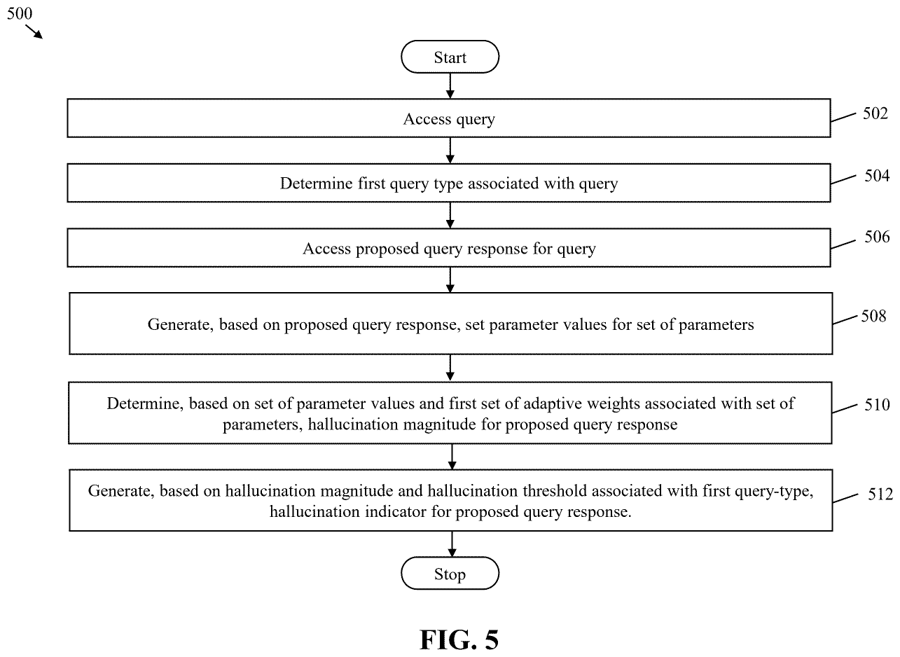

FIG. 5 illustrates a flowchart 500 that depicts a method for detection of hallucination, consistent with disclosed embodiments of the present disclosure.

At 502, the query may be accessed. The processing circuitry 118 may be configured to access the query. In an example, the processing circuitry 118 may receive the query from the user device 108. At 504, the first query-type associated with the query may be determined. The processing circuitry 118 may be configured to determine the first query-type. At 506, the proposed query response for the query may be accessed. The processing circuitry 118 may be configured to access the proposed query response. At 508, the set of parameter values for the set of parameters may be generated. The processing circuitry 118 may be configured to generate the set of parameter values for the set of parameters based on the proposed query response.

At 510, based on the set of parameter values and the first set of adaptive weights associated with the set of parameters for the first query-type, the hallucination magnitude for the proposed query response may be determined. The processing circuitry 118 may be configured to determine the hallucination magnitude for the proposed query response based on the set of parameter values and the first set of adaptive weights associated with the set of parameters for the first query-type. At 512, based on the hallucination magnitude and the hallucination threshold associated with the first query-type, the hallucination indicator for the proposed query response may be generated. The processing circuitry 118 may be configured to generate the hallucination indicator based on the hallucination magnitude and the hallucination threshold associated with the first query-type. The hallucination indicator may be indicative of the presence of the hallucination in the proposed query response based on the hallucination magnitude being greater than the hallucination threshold. The hallucination indicator may be indicative of the absence of the hallucination in the proposed query response based on the hallucination magnitude being less than the hallucination threshold.

The hallucination detection system 102 described herein provides numerous advantages, including a scalable, resilient, and responsive approach for the detection of hallucination in text generated by text generating systems. The hallucination detection system 102 leverages indicators, such as the brevity score, the entropy indicator, the inter-token delay, and the cosine similarity, that allow for optimal detection of hallucination in the text in real-time. Real-time detection of presence or absence of hallucination in text may significantly overcome the requirement of post-response generation fact-checking, thereby aiding in the efficient utilization of computing resources. The hallucination detection system 102 disclosed herein further supports adaptation of weights and threshold values for accurate hallucination detection for varying query-types. The adaptive weight allows for varying and dynamic value or importance being given to different parameters (such as, the brevity score, the entropy indicator, the inter-token delay, and the cosine similarity) for various query-types (for example, the factual query-type, the procedural query-type, the creative query-type, the mythical query-type, or the unknown query-type). The adaptive thresholds for the parameters allow for varying and dynamic maximum or minimum permissible parameter values for different parameters for various query-types for detecting the presence or absence of hallucination. To summarize, the hallucination detection is performed in real-time, which allows text (for example, query response for a query) to be generated with an indicated presence or absence of hallucination therein.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for hallucination detection in text generating system. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

What is claimed is:

1. A system, comprising:
processing circuitry configured to:
access a query;
determine a first query-type associated with the query;
access a proposed query response for the query;
generate, based on the proposed query response, a set of parameter values for a set of parameters, wherein the set of parameter values is indicative of a degree of grounding associated with the proposed query response;
determine, based on the set of parameter values and a first set of adaptive weights associated with the set of parameters, a hallucination magnitude for the proposed query response; and
generate, based on the hallucination magnitude and a hallucination threshold associated with the first query-type, a hallucination indicator for the proposed query response.

2. The system of claim 1,
wherein the processing circuitry is further configured to compare the hallucination magnitude and the hallucination threshold,
wherein the hallucination indicator indicates a presence of hallucination in the proposed query response based on the hallucination magnitude being greater than the hallucination threshold, and
wherein the hallucination indicator indicates an absence of hallucination in the proposed query response based on the hallucination magnitude being less than the hallucination threshold.

3. The system of claim 1,
wherein the processing circuitry is further configured to analyze the query to determine the first query-type from a plurality of query-types,
wherein for each query-type of the plurality of query-types, the set of parameters is associated with a corresponding set of adaptive weights, and
wherein the first set of adaptive weights is determined further based on the first query-type being associated with the query.

4. The system of claim 3, wherein the processing circuitry is further configured to:
parse a set of query tokens in the query; and
determine a contextual intent of each query token of the set of query tokens, wherein the query is analyzed based on the contextual intent of each query token of the set of query tokens.

5. The system of claim 3, wherein the plurality of query-types include at least two of: a factual query-type, a procedural query-type, a creative query-type, a mythical query-type, or an unknown query-type.

6. The system of claim 1,
wherein the set of parameters includes at least one of: a brevity score, an entropy indicator, an inter-token delay, or a cosine similarity,
wherein a first parameter value for the brevity score is generated by utilizing a first count of tokens in a first set of tokens pertaining to the proposed query response and a second count of tokens in a second set of tokens pertaining to a ground truth response for the query,
wherein a second parameter value for the entropy indicator is generated by utilizing information contribution of each token of the first set of tokens,
wherein a third parameter value for the inter-token delay is generated by utilizing a time-interval between generation of two adjacent tokens in the first set of tokens,
wherein a fourth parameter value for the cosine similarity is generated by utilizing a vector representation of the query and the proposed query response, and
wherein the first parameter value, the second parameter value, the third parameter value, and the fourth parameter value, collectively, constitute the set of parameter values.

7. The system of claim 6, further includes a storage element coupled to the processing circuitry, wherein the processing circuitry is further configured to:
create a database associated with a subject area of the first query-type;
store the database in the storage element; and
generate, based on the query being associated with the first query-type, the ground truth response for the query by utilizing the database.

8. The system of claim 1, wherein the processing circuitry is further configured to:
compare the hallucination indicator with an actual hallucination state associated with the proposed query response;
determine, based on the hallucination indicator being different from the actual hallucination state, that the hallucination indicator corresponds to one of a false-positive hallucination indicator or a false-negative hallucination indicator; and
generate, based on the hallucination indicator corresponding to one of the false-positive hallucination indicator or the false-negative hallucination indicator, a new set of adaptive weights associated with the set of parameters for the first query-type, wherein the new set of adaptive weights is generated based on at least one of: the first set of adaptive weights, the hallucination indicator, the actual hallucination state, a pre-defined learning rate for the set of parameters, or a direction of correction associated with the first set of adaptive weights.

9. The system of claim 1, wherein the processing circuitry is further configured to:
generate, for the first query-type, a set of adaptive thresholds for the set of parameters based on at least one of: a historical set of adaptive thresholds associated with the set of parameters for the first query-type, a learning rate associated with the set of parameters for the first query-type, a metric of historical false-positive hallucination indicators for the first query-type, a metric of historical false-negative hallucination indicators for the first query-type, or a direction of correction associated with the historical set of adaptive thresholds; and
determine the hallucination threshold associated with the first query-type based on the set of adaptive thresholds for the set of parameters.

10. A computer-implemented method, comprising:
accessing a query;
determining a first query-type associated with the query;
accessing a proposed query response for the query;
generating, based on the proposed query response, a set of parameter values for a set of parameters, wherein the set of parameter values is indicative of a degree of grounding associated with the proposed query response;
determining, based on the set of parameter values and a first set of adaptive weights associated with the set of parameters, a hallucination magnitude for the proposed query response; and
generating, based on the hallucination magnitude and a hallucination threshold associated with the first query-type, a hallucination indicator for the proposed query response.

11. The computer-implemented method of claim 10, further comprising:
comparing the hallucination magnitude with the hallucination threshold associated with the first query-type, wherein the hallucination indicator indicates a presence of hallucination in the proposed query response based on the hallucination magnitude being greater than the hallucination threshold.

12. The computer-implemented method of claim 10, further comprising:
comparing the hallucination magnitude with the hallucination threshold associated with the first query-type, wherein the hallucination indicator indicates an absence of hallucination in the proposed query response based on the hallucination magnitude being less than the hallucination threshold.

13. The computer-implemented method of claim 10, further comprising:
analyzing the query to determine the first query-type from a plurality of query-types,
wherein for each query-type of the plurality of query-types, the set of parameters is associated with a corresponding set of adaptive weights, and
wherein the first set of adaptive weights is determined further based on the first query-type being associated with the query.

14. The computer-implemented method of claim 13, wherein the plurality of query-types include at least two of: a factual query-type, a procedural query-type, a creative query-type, a mythical query-type, or an unknown query-type.

15. The computer-implemented method of claim 13, further comprising:
parsing a set of query tokens in the query; and
determining a contextual intent of each query token of the set of query tokens, wherein the query is analyzed based on the contextual intent of each query token of the set of query tokens.

16. The computer-implemented method of claim 10,
wherein the set of parameters includes at least one of: a brevity score, an entropy indicator, an inter-token delay, or a cosine similarity,
wherein a first parameter value for the brevity score is generated by utilizing a first count of tokens in a first set of tokens pertaining to the proposed query response and a second count of tokens in a second set of tokens pertaining to a ground truth response for the query,
wherein a second parameter value for the entropy indicator is generated by utilizing information contribution of each token of the first set of tokens,
wherein a third parameter value for the inter-token delay is generated by utilizing a time-interval between generation of two adjacent tokens in the first set of tokens,
wherein a fourth parameter value for the cosine similarity is generated by utilizing a vector representation of the query and the proposed query response, and
wherein the first parameter value, the second parameter value, the third parameter value, and the fourth parameter value, collectively, constitute the set of parameter values.

17. The computer-implemented method of claim 16, further comprising:
creating a database associated with a subject area of the first query-type;
storing the database in a storage element; and
generating, based on the query being associated with the first query-type, the ground truth response for the query by utilizing the database.

18. The computer-implemented method of claim 10, further comprising:
comparing the hallucination indicator with an actual hallucination state associated with the proposed query response;
determining, based on the hallucination indicator being different from the actual hallucination state, that the hallucination indicator corresponds to one of a false-positive hallucination indicator or a false-negative hallucination indicator; and
generating, based on the hallucination indicator corresponding to one of the false-positive hallucination indicator or the false-negative hallucination indicator, a new set of adaptive weights associated with the set of parameters for the first query-type, wherein the new set of adaptive weights is generated based on at least one of: the first set of adaptive weights, the hallucination indicator, the actual hallucination state, a pre-defined learning rate for the set of parameters, or a direction of correction associated with the first set of adaptive weights.

19. The computer-implemented method of claim 10, further comprising:
generating, for the first query-type, a set of adaptive thresholds for the set of parameters based on at least one of: a historical set of adaptive thresholds associated with the set of parameters for the first query-type, a learning rate associated with the set of parameters for the first query-type, a metric of historical false-positive hallucination indicators for the first query-type, a metric of historical false-negative hallucination indicators for the first query-type, or a direction of correction associated with the historical set of adaptive thresholds; and
determining the hallucination threshold associated with the first query-type based on the set of adaptive thresholds for the set of parameters.

20. A computer-readable medium comprising instructions that, when executed by processing circuitry of a computing system, cause the computing system to perform a method for detection of hallucination in a proposed query response for a query, the method comprising:
accessing the query;
determining a first query-type associated with the query;
accessing the proposed query response for the query;
generating, based on the proposed query response, a set of parameter values for a set of parameters, wherein the set of parameter values is indicative of a degree of grounding associated with the proposed query response;
determining, based on the set of parameter values and a first set of adaptive weights associated with the set of parameters, a hallucination magnitude for the proposed query response; and
generating, based on the hallucination magnitude and a hallucination threshold associated with the first query-type, a hallucination indicator for the proposed query response.
